(19) United States
(12) Patent Application Publication
(10) Pub. No.: US 2026/0126735 A1
(43) Pub. Date: May 7, 2026

(54) IMAGE FORMING APPARATUS

(71) Applicant: KYOCERA Document Solutions Inc., Osaka (JP)

(72) Inventors: Minoru Shinba, Osaka (JP); Shunsuke Sasaki, Osaka (JP)

(21) Appl. No.: 19/379,033

(22) Filed: Nov. 4, 2025

(30) Foreign Application Priority Data
Nov. 7, 2024 (JP) 2024-194860

(51) Int. Cl. G03G 15/01; G03G 15/00

(52) U.S. Cl. CPC G03G 15/0178; G03G 15/0121; G03G 15/0131; G03G 15/50

(57) ABSTRACT

An image forming apparatus includes plural image forming units corresponding to plural toner colors, and a controller. The controller is configured to read and write data to respective non-volatile unit memories in the plural image forming units. Further, a common address is assigned to the non-volatile unit memories of the plural image forming units Furthermore, the controller comprises a switching unit configured to switch an image forming unit to which the data should be read or written among the plural image forming units.

### CROSS-REFERENCE TO RELATED APPLICATIONS

This application relates to and claims priority rights from Japanese Patent Application No. 2024-194860, filed on Nov. 7, 2024, the entire disclosures of which are hereby incorporated by reference herein.

### BACKGROUND

### 1. Field of the Present Disclosure

The present disclosure relates to an image forming apparatus.

### 2. Description of the Related Art

An image forming apparatus includes a control-program transmitting device, plural operation units, and a communication line to which the control-program transmitting device and the plural operation units are connected, and the control-program transmitting device individually stores respective control programs to the plural operation units through the communication line.

In the aforementioned image forming apparatus, since the communication line of a bus type is used, unique addresses are assigned to plural operation units, respectively. Therefore, it is required to individually set in advance to the plural operation units, and an operation in manufacture of the apparatus is complicated.

### SUMMARY

An image forming apparatus according to an aspect of the present disclosure includes plural image forming units corresponding to plural toner colors, and a controller. The controller is configured to read and write data to respective non-volatile unit memories in the plural image forming units. Further, a common address is assigned to the non-volatile unit memories of the plural image forming units. Furthermore, the controller includes a switching unit configured to switch an image forming unit to which the data should be read or written among the plural image forming units.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an image forming apparatus according to an embodiment of the present disclosure; and

FIG. 2 shows a diagram that indicates a relationship between addresses of drum units 21Y, 21M, 21C, 21K and development units 22Y, 22M, 22C, 22K and values of a switch control signal.

### DETAILED DESCRIPTION

Hereinafter, an embodiment according to an aspect of the present disclosure will be explained with reference to drawings.

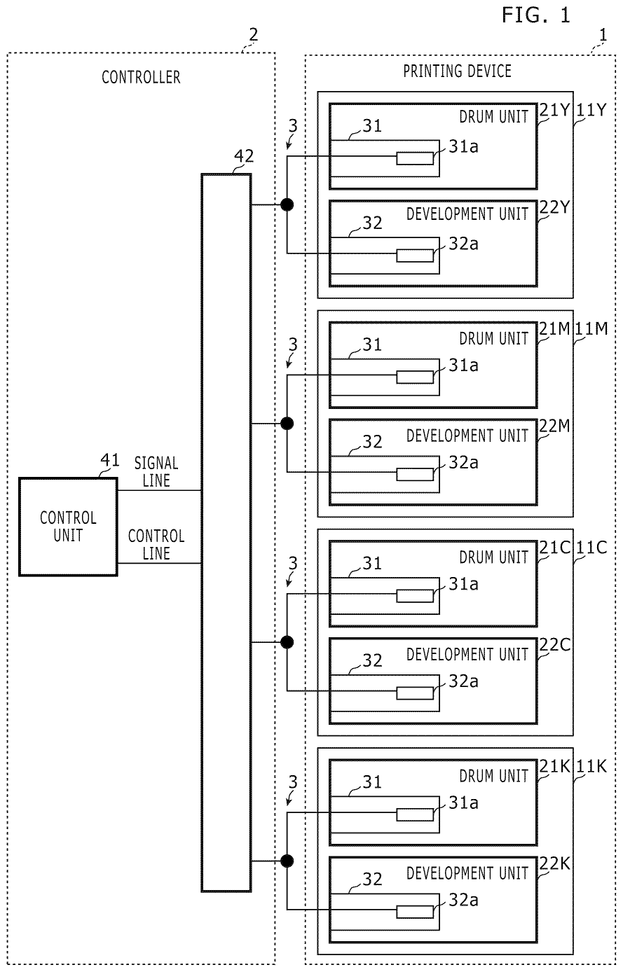

FIG. 1 shows a block diagram that indicates a configuration of an image forming apparatus according to an embodiment of the present disclosure. The image processing apparatus shown in FIG. 1 is, for example, an image forming apparatus such as a multi function peripheral. The image processing apparatus shown in FIG. 1 includes a printing device 1 and a controller 2.

The printing device 1 transports a print sheet from a sheet feeding cassette and prints on the print sheet an image based on image data in an electrographic manner. Specifically, the printing device 1 includes photoconductor drums, exposure devices that expose the photoconductor drums and thereby form electrostatic latent images, development devices that attach toner to the electrostatic latent images on the photoconductor drums and thereby form toner images, a fuser that fixes the toner images transferred onto the print sheet, and the like.

In case of a color image forming apparatus of Cyan, Magenta, Yellow and Black (CMYK), this image forming apparatus includes image forming parts 11Y, 11M, 11C and 11K for the four toner colors. Each of the image forming parts 11Y, 11M, 11C and 11K includes plural image forming units for each of plural toner colors.

The image forming part 11Y for Yellow includes a drum unit 21Y that includes as the image forming units a photoconductor drum, and a development unit 22Y that includes a development device. A toner cartridge of Yellow toner is mounted to the development unit 22Y.

The image forming part 11M for Magenta includes a drum unit 21M that includes as the image forming units a photoconductor drum, and a development unit 22M that includes a development device. A toner cartridge of Magenta toner is mounted to the development unit 22M.

The image forming part 11C for Cyan includes a drum unit 21C that includes as the image forming units a photoconductor drum, and a development unit 22C that includes a development device. A toner cartridge of Cyan toner is mounted to the development unit 22C.

The image forming part 11K for Black includes a drum unit 21K that includes as the image forming units a photoconductor drum, and a development unit 22K that includes a development device. A toner cartridge of Black toner is mounted to the development unit 22K.

Each of the drum units 21Y, 21M, 21C and 21K includes a circuit board 31 on which a non-volatile unit memory 31a has been installed. Same circuit boards may be used as the circuit boards 31 in the drum units. Further, each of the development units 22Y, 22M, 22C and 22K includes a circuit board 32 on which a non-volatile unit memory 32a has been installed. Same circuit boards may be used as the circuit boards 32 in the development units. The unit memories 31a and 32a are EEPROMs (Electrically Erasable Programmable Read-Only Memories) or the like.

In the unit memory 31a or 32a in the unit 21Y, 21M, 21C, 21K, 22Y, 22M, 22C or 22K, for example, stored are (a) a driving distance or the like that indicates replacement timing of this unit, (b) image forming characteristic data of this unit and the like.

Each of the image forming parts 11Y, 11M, 11C and 11K also includes a transfer unit (not shown) that transfers the toner image from the photoconductor drum to the print sheet of an intermediate transfer belt, and the like. Specifically, the transfer unit includes a high-voltage power supply and the like.

Further, the controller 2 includes a control unit 41 and a switching unit 42.

The control unit 41 includes an ASIC (Application Specific Integrated Circuit) and a computer that includes a CPU (Central Processing Unit), a ROM (Read Only Memory), a RAM (Random Access Memory) and the like and executes a predetermined program and the like, and performs various processes using the ASIC, the computer and/or the like.

Specifically, the control unit 41 receives job requests for sorts of jobs, and upon receiving a job request, performs a job specified by the job request. For example, the controller 2 receives a job request for a print job, and upon receiving the job request, performs a data process (raster process and/or the like) and/or an image process (screen process and/or the like) for image data specified by the job request and thereby generates image data for printing, and performs the print job using the printing device 1 on the basis of the generated image data.

Further, the control unit 41 performs data communication with each of the unit memories 31a and 32a (i.e. read or write of data as mentioned). This data communication is wired data communication, for example, and is performed through a connector physically connected when the unit 21Y, 21M, 21C, 21K, 22Y, 22M, 22C or 22K is mounted.

The switching unit 42 is a switch IC (Integrated Circuit) that selects an output destination of an input signal among plural output destinations correspondingly to a value of a switch control signal from the control unit 41.

Here, the switching unit 42 switches an image forming unit to which the data should be read or written by the control unit 41 among the plural image forming units.

Further, this image forming apparatus includes plural individual signal lines 3. The plural individual signal lines 3 include data lines and address lines and individually connect the plural image forming units to the switching unit 42. Specifically, the plural individual signal lines 3 individually connect the plural drum units 21Y, 21M, 21C and 21K to the switching unit 42, and the plural individual signal lines 3 individually connect the plural development units 22Y, 22M, 22C and 22K to the switching unit 42. The control unit 41 and the switching unit 42 are connected with each other by a common signal line (a data line and an address line).

A common address is assigned to the unit memories in the plural image forming units. Specifically, a common address is assigned to the unit memories 31a in the plural drum units 21Y, 21M, 21C and 21K; and a common address is assigned to the unit memories 32a in the plural development units 22Y, 22M, 22C and 22. Further, the address assigned to the unit memories 32a is different from the address assigned to the unit memories 31a.

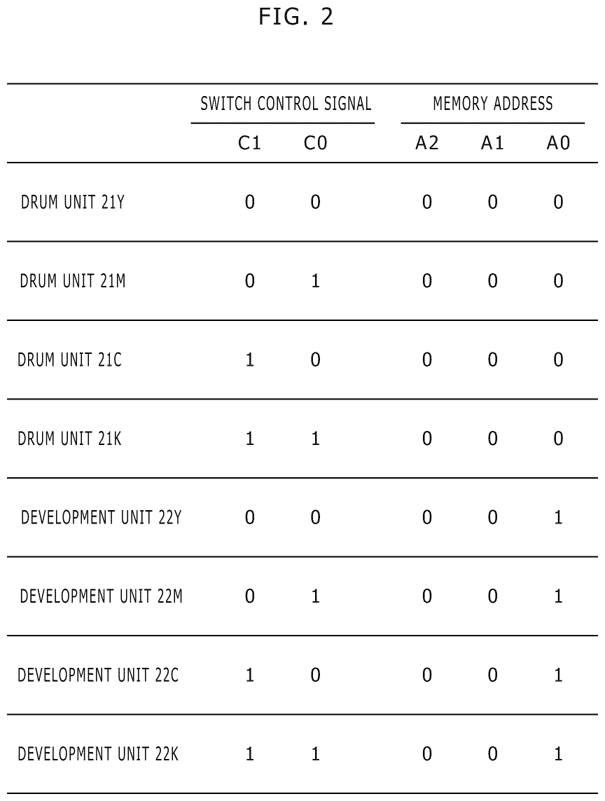

FIG. 2 shows a diagram that indicates a relationship between addresses of drum units 21Y, 21M, 21C, 21K and development units 22Y, 22M, 22C, 22K and values of a switch control signal.

The switch control signal is a signal of 2 bits (C1, C0) and here is transmitted as individual binary signals through two lines, and as shown in FIG. 2, for example, one of the image forming parts is selected correspondingly to a value of the switch control signal. Thus, correspondingly to a value of the switch control signal, one of the drum units 21Y, 21M, 21C and 21K and one of the development units 22Y, 22M, 22C and 22K are selected.

Further, in a case shown in FIG. 2, a common address (0, 0, 0) is assigned to the drum units 21Y, 21M, 21C and 21K; and a common address (0, 0, 1) is assigned to the development units 22Y, 22M, 22C and 22K.

The following part explains a behavior of the aforementioned image forming apparatus.

When the control unit 41 accesses a unit memory in one of the image forming units, the control unit 41 outputs a switch control signal having a value corresponding to this image forming unit to the switching unit 42, and thereby causes the switching unit 42 to select an image forming part that this image forming unit.

Subsequently, the control unit 41 performs a data read or write operation to an address of this image forming unit through the switching unit 42 and the individual signal line 3.

For example, when the control unit 41 accesses the unit memory 31a in the drum unit 21C, the control unit 41 provides a switch control signal having a value (1, 0) to the switching unit 42, and performs a data read or write operation to the address (0, 0, 0).

As mentioned, in the aforementioned embodiment, the controller 2 reads and writes data to respective non-volatile unit memories in the plural image forming units. Further, a common address is assigned to the unit memories in the plural image forming units, and the controller 2 includes the switching unit 42 that switches an image forming unit to which the data should be read or written among the plural image forming units.

Consequently, communication parts (the aforementioned circuit board or the like) in the image forming units are commonized, and thereby a cost and an operation in manufacture of the apparatus are lowered.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. An image forming apparatus, comprising:
plural image forming units corresponding to plural toner colors; and
a controller configured to read and write data to respective non-volatile unit memories in the plural image forming units;
wherein a common address is assigned to the non-volatile unit memories of the plural image forming units; and
the controller comprises a switching unit configured to switch an image forming unit to which the data should be read or written among the plural image forming units.

2. The image forming apparatus according to claim 1, further comprising plural individual signal lines configured to connect the plural image forming units to the switching unit.

3. The image forming apparatus according to claim 1, wherein the plural image forming units are any of: plural drum units that comprise respective photoconductor drums, plural development units configured to adhere toner to electrostatic latent images on the photoconductor drums and thereby form respective toner images, and plural transfer units configured to transfer the toner images.

4. The image forming apparatus according to claim 1, wherein the plural image forming units comprise plural drum units that comprise respective photoconductor drums, and plural development units that comprise respective development devices;
a common first address is assigned to the unit memories of the plural drum units;
a common second address is assigned to the unit memories of the plural development units; and
the second address is different from the first address.
